(19) United States
(12) Patent Application Publication
(10) Pub. No.: US 2026/0247258 A1
(43) Pub. Date: Aug. 20, 2026

(54) TERMINAL DEVICES, NETWORK DEVICE, AND METHODS FOR MULTI-PATH COMMUNICATIONS

(71) Applicant: LENOVO (BEIJING) LIMITED, Beijing (CN)

(72) Inventors: Lianhai WU, Beijing (CN); Ran YUE, Beijing (CN); Yibin ZHUO, Beijing (CN); Min XU, Beijing (CN); Haiming WANG, Beijing (CN)

(21) Appl. No.: 19/472,523

(22) PCT Filed: Apr. 6, 2023
(86) PCT No.: PCT/CN2023/086686

§ 371 Date: Oct. 3, 2025

(51) Int. Cl. H04W 40/34; H04W 88/04

(52) U.S. Cl. CPC H04W 40/34; H04W 88/04

(57) ABSTRACT

Embodiments of the present disclosure relate to a solution for MP communications. In one aspect of the solution, a terminal device receives, from a first network device serving the terminal device, a first reconfiguration message for mobility of the terminal device. The first reconfiguration message comprises a configuration for multiple paths related to a second network device. The terminal device accesses the second network device by establishing at least one of the multiple paths based on the first reconfiguration message. The terminal device transmits a reconfiguration complete message to the second network device.

### FIELD

Embodiments of the present disclosure generally relate to the field of communication, and in particular to terminal device, network devices, and methods for multi-path (MP) communications.

### BACKGROUND

As the number of mobile devices within wireless networks and the demand for mobile data traffic continue to increase, changes are made to system requirements and architectures to better address current and anticipated demands. For example, some wireless communication networks (e.g., fifth generation (5G) or new radio (NR) networks) may be developed to include user equipment (UE) to network (NW) (U2N) relay communications. In such scenarios, UE mobility with multiple paths needs to be discussed.

### SUMMARY

In general, embodiments of the present disclosure provide a solution for MP communications.

In a first aspect, there is provided a terminal device. The terminal device comprises a processor and a transceiver coupled to the processor. The processor is configured to: receive, via the transceiver from a first network device serving the terminal device, a first reconfiguration message for mobility of the terminal device, the first reconfiguration message comprising a configuration for multiple paths related to a second network device; and access the second network device by establishing at least one of the multiple paths based on the first reconfiguration message; and transmit a reconfiguration complete message via the transceiver to the second network device.

In a second aspect, there is provided a first network device. The first network device comprises a processor and a transceiver coupled to the processor. The processor is configured to: transmit, via the transceiver to a second network device, a request for mobility of a terminal device served by the first network device, the request being associated with multiple paths related to the second network device; and receive a response via the transceiver from the second network device based on the reception of the request, the response comprising a configuration for at least one of the multiple paths.

In a third aspect, there is provided a second network device. The second network device comprises a processor and a transceiver coupled to the processor. The processor is configured to: receive, via the transceiver from a first network device, a request for mobility of a terminal device served by the first network device, the request being associated with multiple paths; and transmit a response via the transceiver to the first network device based on the reception of the request, the response comprising a configuration for at least one of the multiple paths.

In a fourth aspect, there is provided a method performed by a terminal device. The method comprises: receiving, at a terminal device from a first network device serving the terminal device, a first reconfiguration message for mobility of the terminal device, the first reconfiguration message comprising a configuration for multiple paths related to a second network device; and accessing the second network device by establishing at least one of the multiple paths based on the first reconfiguration message; and transmitting a reconfiguration complete message to the second network device.

In a fifth aspect, there is provided a method performed by a first network device. The method comprises: transmitting, from a first network device to a second network device, a request for mobility of a terminal device served by the first network device, the request being associated with multiple paths related to the second network device; and receiving a response from the second network device based on the reception of the request, the response comprising a configuration for at least one of the multiple paths.

In a sixth aspect, there is provided a method performed by a second network device. The method comprises: receiving, at a second network device from a first network device, a request for mobility of a terminal device served by the first network device, the request being associated with multiple paths; and transmitting a response to the first network device based on the reception of the request, the response comprising a configuration for at least one of the multiple paths.

In a seventh aspect, there is provided a computer readable medium. The computer readable medium has instructions stored thereon. The instructions, when executed on at least one processor of a device, causing the device to perform the method of the fourth, fifth or sixth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some embodiments will now be described with reference to the accompanying drawings in which:

FIGS. 1A and 1B illustrate a schematic diagram of a communication environment in which some embodiments of the present disclosure can be implemented, respectively;

FIG. 2 illustrates a signaling chart illustrating an example process for MP communications in accordance with some embodiments of the present disclosure;

FIG. 3 illustrates a signaling chart illustrating an example process for MP communications in accordance with other embodiments of the present disclosure;

FIG. 4 illustrates a signaling chart illustrating an example process for MP communications in accordance with still other embodiments of the present disclosure;

FIG. 5 illustrates a flowchart of a method implemented at a terminal device in accordance with some embodiments of the present disclosure;

FIG. 6 illustrates a flowchart of a method implemented at a network device in accordance with other embodiments of the present disclosure;

FIG. 7 illustrates a flowchart of a method implemented at a network device in accordance with some embodiments of the present disclosure; and

FIG. 8 illustrates a simplified block diagram of an apparatus that is suitable for implementing embodiments of the present disclosure.

Throughout the drawings, the same or similar reference numerals represent the same or similar elements.

### DETAILED DESCRIPTION

Principles of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below. In the following description and claims, unless defined otherwise, all technical and scientific terms used herein have the same meaning as commonly understood by one of ordinary skills in the art to which this disclosure belongs.

References in the present disclosure to “one embodiment,” “an example embodiment,” “an embodiment,” “some embodiments,” and the like indicate that the embodiment(s) described may include a particular feature, structure, or characteristic, but it is not necessary that every embodiment includes the particular feature, structure, or characteristic. Moreover, such phrases do not necessarily refer to the same embodiment(s). Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are only used to distinguish one element from another element. For example, a first element could also be termed as a second element, and similarly, a second element could also be termed as a first element, without departing from the scope of embodiments. As used herein, the term “and/or” includes any and all combinations of one or more of the listed terms. In some examples, values, procedures, or apparatuses are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

The terminology used herein is for the purpose of describing particular embodiments only and is not intended to be limiting of embodiments. As used herein, the singular forms “a,” “an” and “the” are intended to include the plural forms as well, unless the context clearly indicates otherwise. It will be further understood that the terms “comprises,” “comprising,” “has,” “having,” “includes” and/or “including,” when used herein, specify the presence of stated features, elements, components and/or the like, but do not preclude the presence or addition of one or more other features, elements, components and/or combinations thereof. For example, the term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The use of an expression such as “A and/or B” can mean either “only A” or “only B” or “both A and B.” Other definitions, explicit and implicit, may be included below.

As used herein, the term “communication network” refers to a network following any suitable communication standards, such as, 5G NR, Long Term Evolution (LTE), LTE-Advanced (LTE-A), Wideband Code Division Multiple Access (WCDMA), High-Speed Packet Access (HSPA), Narrow Band Internet of Things (NB-IOT), and so on. Further, the communications between a terminal device and a network device in the communication network may be performed according to any suitable generation communication protocols, including but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will also be future type communication technologies and systems in which the present disclosure may be embodied. It should not be seen as limiting the scope of the present disclosure to only the aforementioned systems.

As used herein, the term “network device” generally refers to a node in a communication network via which a terminal device can access the communication network and receive services therefrom. The network device may refer to a base station (BS) or an access point (AP), for example, a node B (NodeB or NB), a radio access network (RAN) node, an evolved NodeB (eNodeB or eNB), a NR NB (also referred to as a gNB), a Remote Radio Unit (RRU), a radio header (RH), an infrastructure device for a V2X (vehicle-to-everything) communication, a transmission and reception point (TRP), a reception point (RP), a remote radio head (RRH), a relay, an integrated access and backhaul (IAB) node, a low power node such as a femto BS, a pico BS, and so forth, depending on the applied terminology and technology.

As used herein, the term “terminal device” generally refers to any end device that may be capable of wireless communications. By way of example rather than a limitation, a terminal device may also be referred to as a communication device, a user equipment (UE), an end user device, a subscriber station (SS), an unmanned aerial vehicle (UAV), a portable subscriber station, a mobile station (MS), or an access terminal (AT). The terminal device may include, but is not limited to, a mobile phone, a cellular phone, a smart phone, a voice over IP (VOIP) phone, a wireless local loop phone, a tablet, a wearable terminal device, a personal digital assistant (PDA), a portable computer, a desktop computer, an image capture terminal device such as a digital camera, a gaming terminal device, a music storage and playback appliance, a vehicle-mounted wireless terminal device, a wireless endpoint, a mobile station, laptop-embedded equipment (LEE), laptop-mounted equipment (LME), a USB dongle, a smart device, wireless customer-premises equipment (CPE), an Internet of Things (IOT) device, a watch or other wearable, a head-mounted display (HMD), a vehicle, a drone, a medical device (for example, a remote surgery device), an industrial device (for example, a robot and/or other wireless devices operating in an industrial and/or an automated processing chain contexts), a consumer electronics device, a device operating on commercial and/or industrial wireless networks, and the like. In the following description, the terms: “terminal device,” “communication device,” “terminal,” “user equipment” and “UE,” may be used interchangeably.

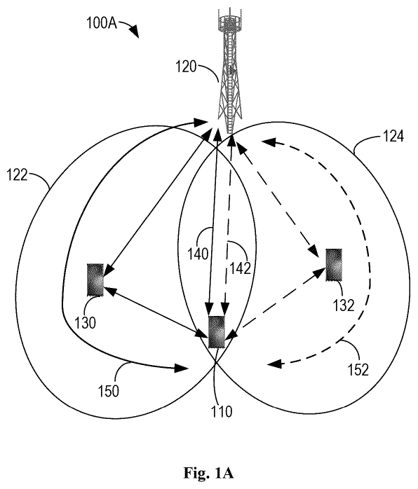

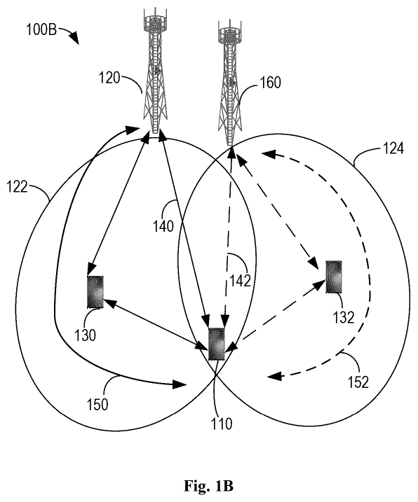

FIGS. 1A and 1B illustrate schematic diagrams of communication environments 100A and 100B in which some embodiments of the present disclosure can be implemented. Each of the communication environments 100A and 100B may comprise a terminal device 110, a first network device 120, and terminal devices 130 and 132. Hereinafter the terminal devices 110, 130 and 132 may also be referred to as the UE 110, UE 130 and UE 132, respectively.

The terminal device 110 may be in coverage of a cell 122 of the first network device 120. In this case, the terminal device 110 may be connected to the first network device 120 using a direct path 140.

In some embodiments, an interface between the terminal device 110 and the first network device 120 may be a Uu interface.

In some embodiments, in order to extend cell coverage and provide reachability for cell-edge users (or out-of-coverage users), an indirect path 150 may be established and added after the direct path 140 was established. Thus, the terminal device 110 may be connected to the first network device 120 using the indirect path 150 via the terminal device 130. In this case, the terminal device 130 is also referred to as a U2N relay UE 130, and the terminal device 110 is also referred to as a remote UE 110.

It shall be understood that although it is shown in FIGS. 1A and 1B that the terminal device 130 is in coverage of a cell 122 of the first network device 120, the terminal device 130 may be in coverage of other cell than the cell 122 of the first network device 120.

In the present disclosure, a direct path may also be referred to as a direct link or direct leg, and an indirect path may also be referred to as an indirect link or indirect leg.

In some embodiments, an interface between the terminal device 130 and the first network device 120 may be a Uu interface, and an interface between the terminal device 110 and the terminal device 130 may be a PC5 interface. In such embodiments, a connection between the terminal device 110 and the terminal device 130 may be a PC5-Radio Resource Control (RRC) connection.

In some embodiments, the terminal device 110 may move out of coverage of the cell 122 and into coverage of a cell 124 of the first network device 120. In such embodiments, handover of the terminal device 130 from the cell 122 to the cell 124 may be performed. In such embodiments, the cell 122 and the cell 124 are referred to as a source cell 122 and a target cell 124.

In the example of FIG. 1A, because both the source cell 122 and the target cell 124 are provided by the first network device 120, the first network device 120 acts as both a source network device and a target network device. In other words, the source network device may be the same as the target network device. In the present disclosure, mobility of the terminal device 110 in the example of FIG. 1A is also referred to as intra-gNB mobility.

The example of FIG. 1B is different from the example of FIG. 1A in that the source cell 122 is provided by the first network device 120 and the target cell 124 is provided by a second network device 160. Thus, the first network device 120 acts as a source network device and the second network device 160 acts as a target network device. In other words, the source network device may be different from the target network device. In the present disclosure, mobility of the terminal device 110 in the example of FIG. 1B is also referred to as inter-gNB mobility.

In some embodiments, the target network device 120 or 160 may configure multiple paths to the terminal device 110. For example, as shown in FIG. 1A or 1B, the multiple paths comprise a direct path 142 and an indirect path 152. The terminal device 110 may access the target network device 120 or 160 by establishing the direct path 142 and the indirect path 152.

It shall be appreciated that FIGS. 1A and 1B show that the terminal device 110 is connected to the source network device 120 using the direct path 140 and the indirect path 150 by way of example. In other embodiments, the terminal device 110 may be connected to the source network device 120 using one of the direct path 140 and the indirect path 150. The scope of the present disclosure is not limited in this regard.

It is to be understood that the numbers of the network devices and terminal devices are only for ease of understanding without suggesting any limitations. The communication environments 100A and 100B may include any suitable number or type of the network devices and terminal devices adapted for implementing embodiments of the present disclosure.

Communications in the communication environments 100A and 100B may be implemented according to any proper communication protocol(s), comprising, but not limited to, cellular communication protocols of the first generation (1G), the second generation (2G), the third generation (3G), the fourth generation (4G), the fifth generation (5G) or the future sixth generation (6G) wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

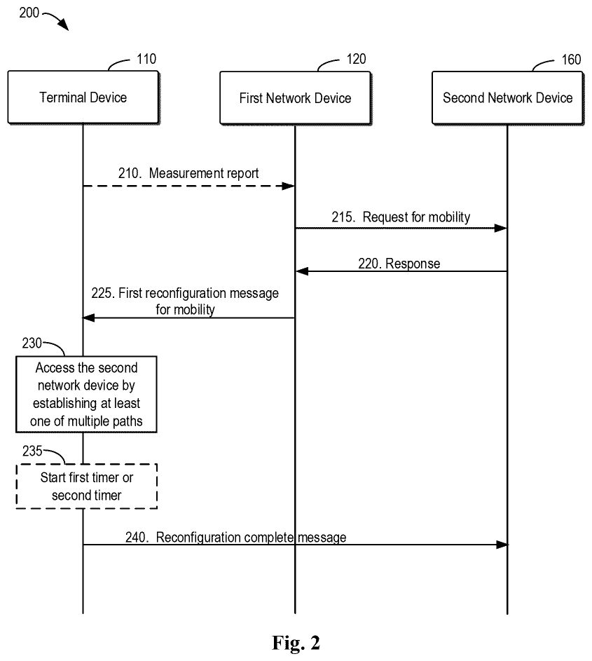

FIG. 2 illustrates a signaling chart illustrating an example process 200 for MP communications in accordance with some embodiments of the present disclosure. In some embodiments, the process 200 may be performed in the environment 100A in FIG. 1A. In such embodiments, the process 200 may involve the terminal device 110 and the first network device 120. In other embodiments, the process 200 may be performed in the environment 100B in FIG. 1B. In such embodiments, the process 200 may involve the terminal device 110, the first network device 120 and the second network device 160. For the purpose of discussion, the process 200 will be described with reference to FIG. 1B.

Generally, in the process 200, the terminal device 110 may be connected to the source network device 120 using at least one of the direct path 140 and the indirect path 150. The terminal device 110 may stay in a radio resource control (RRC) connected state.

As shown in FIG. 2, the terminal device 110 may transmit 210 a measurement result associated with neighbour cell or candidate relay based on configuration from the first network device 120.

Based on the measurement result, the first network device 120 may decide to perform a handover of the terminal device 110 from the cell 122 to the cell 124. Thus, the first network device 120 transmits 215, to the second network device 160, a request for mobility of the terminal device 110 served by the first network device 120. The request is associated with multiple paths related to the second network device 160.

In some embodiments, the first network device 120 may transmit the request by transmitting a handover request message comprising the request. Details of the request for mobility of the terminal device 110 will be described later.

If the second network device 160 accepts the request, the second network device 160 transmits 220 to the first network device 120 a response based on the reception of the request. The response comprises a configuration for at least one of the multiple paths. For example, the response may comprise a configuration for at least one of the direct path 142 and the indirect path 152.

In some embodiments, the second network device 160 may transmit the response by transmitting a handover request acknowledge message comprising the response. Details of the response will be described later.

Upon receiving the response, the first network device 120 transmits 225, to the terminal device 110, a first reconfiguration message for mobility of the terminal device 110. The first reconfiguration message comprises the configuration for the multiple paths related to the second network device 160.

In some embodiments, the first network device 120 may transmit the first reconfiguration message by transmitting an RRC reconfiguration message.

In some embodiments, the first reconfiguration message may comprise an identifier (ID) of a target cell (such as the cell 124) and at least one ID of at least one target relay UE (such as the terminal device 132).

In some embodiments, the first reconfiguration message may comprise a first timer and a second timer. The first timer may be for direct path establishment and configured to perform random access towards the target cell. The second timer may be for indirect path establishment and configured for PC5 link establishment towards the target relay UE. For example, the first timer may be T304 and the second timer may be T420.

Upon receiving the first reconfiguration message, the terminal device 110 accesses 230 the second network device 160 by establishing at least one of the multiple paths based on the first reconfiguration message. For example, the terminal device 110 may perform a path switch procedure to establish at least one of the multiple paths.

In some embodiments, the order in which the terminal device 110 establishes the direct path 142 and the indirect path 152 may be up to implementation of the terminal device 110. For example, the terminal device 110 may establish the direct path 142 first and then establish the indirect path 152. Alternatively, the terminal device 110 may establish the indirect path 152 first and then establish the direct path 142.

In some embodiments, in order to establish the direct path 142, the terminal device 110 may perform a Random Access procedure towards the target cell 124.

In some embodiments, in order to establish the indirect path 152, the terminal device 110 may establish a PC5 link towards the target relay UE 132.

In some embodiments, upon receiving the first reconfiguration message, the terminal device 110 may start 235 the first timer or the second timer.

In turn, the terminal device 110 transmits 240 a reconfiguration complete message to the second network device 160. It shall be noted that in embodiments, the first network device 120 acts as both the source network device and the target network device, the terminal device 110 transmits the reconfiguration complete message to the first network device 120.

In some embodiments, the terminal device 110 may transmit the reconfiguration complete message by transmitting an RRC reconfiguration complete message.

In some embodiments, the terminal device 110 may transmit the reconfiguration complete message via the direct path 142.

In some embodiments, the terminal device 110 may transmit the reconfiguration complete message via the direct path 142 based on determining that the direct path 142 is successfully established. For example, the RRC reconfiguration complete message may be transmitted via the direct path 142 once the terminal device 110 successfully accesses the direct path 142 via random access.

In some embodiments, the terminal device 110 may transmit the reconfiguration complete message via the direct path 142 based on determining that the direct path 142 is successfully established and the indirect path 152 is successfully established. For example, the RRC reconfiguration complete message may be transmitted via the direct path 142 once the terminal device 110 successfully accesses the direct path 142 via random access and the terminal device 110 successfully established PC5 link.

In some embodiments, the terminal device 110 may stop the second timer when the terminal device 110 successfully transmits the reconfiguration complete message via the direct path 142.

In some embodiments, the terminal device 110 may transmit the reconfiguration complete message via the direct path 142 based on determining that the direct path 142 is successfully established and the indirect path 152 fails to be established. In some embodiments, the terminal device 110 may determine the indirect path 152 fails to be established if the second timer expires.

In some embodiments, the terminal device 110 may transmit the reconfiguration complete message via the indirect path 152.

In some embodiments, the terminal device 110 may transmit the reconfiguration complete message via the indirect path 152 based on determining that the indirect path 152 is successfully established. For example, the RRC reconfiguration complete message may be transmitted via the indirect path 152 once the terminal device 110 successfully establishes PC5 link.

In some embodiments, the terminal device 110 may transmit the reconfiguration complete message via the indirect path 152 based on determining that the indirect path 152 is successfully established and the direct path 142 is successfully established. For example, the RRC reconfiguration complete message may be transmitted via the indirect path 152 once the terminal device 110 successfully accesses the direct path 142 via random access and the terminal device 110 successfully established PC5 link.

In some embodiments, the terminal device 110 may transmit the reconfiguration complete message via the indirect path 152 based on determining that the indirect path 152 is successfully established and the direct path 142 fails to be established. For example, the RRC reconfiguration complete message may be transmitted via the indirect path 152 once the terminal device 110 fails to access the direct path 142 via random access and the terminal device 110 successfully established PC5 link.

In some embodiments, the terminal device 110 may transmit the reconfiguration complete message via one of the direct path 142 and the indirect path 152 which is first successfully established. In other words, the reconfiguration complete message is transmitted once one of the direct path 142 and the indirect path 152 is successfully established.

For example, if the terminal device 110 establishes the direct path 142 before establishing the indirect path 152, the terminal device 110 may transmit the reconfiguration complete message via the direct path 142.

For another example, if the terminal device 110 may establish the indirect path 152 before establishing the direct path 142, the terminal device 110 may transmit the reconfiguration complete message via the indirect path 152.

In some embodiments, the terminal device 110 may transmit the reconfiguration complete message via any of the multiple paths.

In some embodiments, the terminal device 110 may transmit failure information to the second network device 160 via the available path if one of the direct path 142 and the indirect path 152 fails to be established.

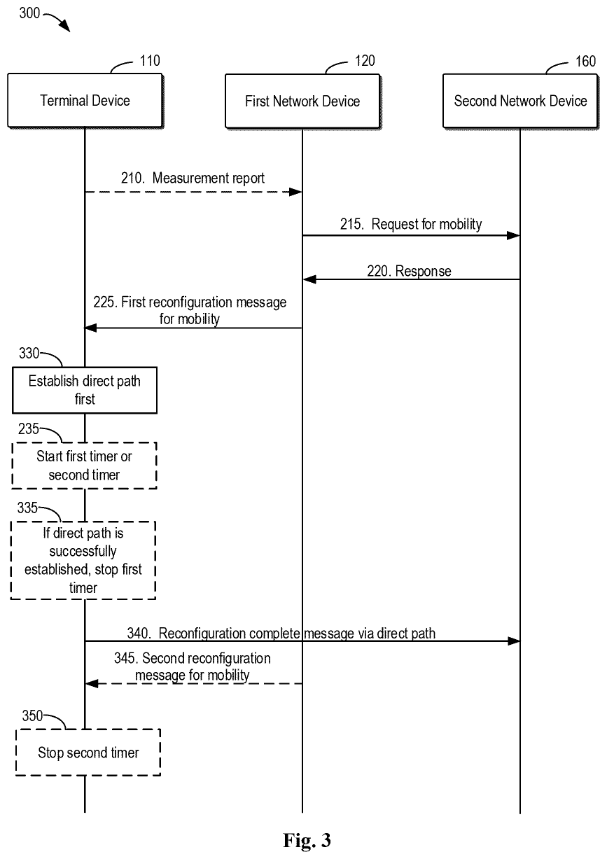

FIG. 3 illustrates a signaling chart illustrating an example process 300 for MP communications in accordance with some embodiments of the present disclosure. In some embodiments, the process 300 may be performed in the environment 100A in FIG. 1A. In such embodiments, the process 300 may involve the terminal device 110 and the first network device 120. In other embodiments, the process 300 may be performed in the environment 100B in FIG. 1B. In such embodiments, the process 300 may involve the terminal device 110, the first network device 120 and the second network device 160. For the purpose of discussion, the process 300 will be described with reference to FIG. 1B.

Generally, in the process 300, the terminal device 110 may be connected to the source network device 120 using at least one of the direct path 140 and the indirect path 150. The terminal device 110 may stay in an RRC connected state.

Actions 210, 215, 220, 225 and 235 in the process 300 are the same as those in the process 200. Details of these actions are omitted for brevity.

The process 300 is different from the process 200 in actions 330, 335, 340, 345 and 350.

Specifically, upon receiving the first reconfiguration message, the terminal device 110 accesses the second network device 160 by establishing at least one of the multiple paths based on the first reconfiguration message. For example, the terminal device 110 may perform a path switch procedure to establish at least one of the multiple paths.

In some embodiments, the order in which the terminal device 110 establishes the direct path 142 and the indirect path 152 may be up to implementation of the terminal device 110. In the process 300, the terminal device 110 may establish 330 the direct path 142 first and then establish the indirect path 152.

For example, the terminal device 110 may perform a Random Access procedure towards the target cell 124 first. The terminal device 110 may establish PC5 link towards the target relay terminal device 132 after the terminal device 110 performs the Random Access procedure towards the target cell 124.

Similar to the process 200, in some embodiments, upon receiving the first reconfiguration message, the terminal device 110 may start 235 the first timer or the second timer. The first timer may be used for direct path establishment and configured to perform random access towards the target cell. The second timer may be used for indirect path establishment and configured for PC5 link establishment towards the target relay UE. For example, the first timer may be T304 and the second timer may be T420.

If the direct path 142 is successfully established, the terminal device 110 stops 335 the first timer.

In turn, the terminal device 110 transmits 340 a reconfiguration complete message to the second network device 160 via the direct path 142.

The terminal device 110 may receive 345, from the first network device 120, a second reconfiguration message indicating that the indirect path 152 is to be released.

In some embodiments, if the terminal device 110 receive the second reconfiguration message while the second timer is running, the terminal device 110 stops 350 the second timer based on the second reconfiguration message.

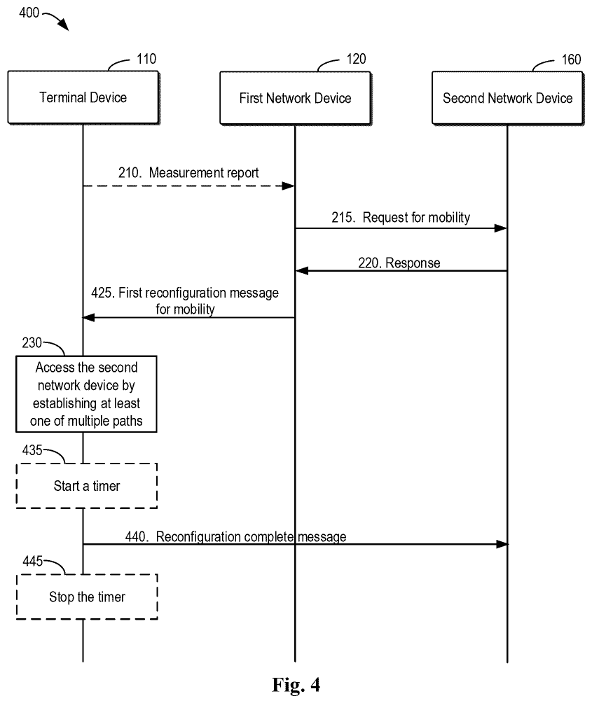

FIG. 4 illustrates a signaling chart illustrating an example process 400 for MP communications in accordance with some embodiments of the present disclosure. In some embodiments, the process 400 may be performed in the environment 100A in FIG. 1A. In such embodiments, the process 400 may involve the terminal device 110 and the first network device 120. In other embodiments, the process 400 may be performed in the environment 100B in FIG. 1B. In such embodiments, the process 400 may involve the terminal device 110, the first network device 120 and the second network device 160. For the purpose of discussion, the process 400 will be described with reference to FIG. 1B.

Generally, in the process 400, the terminal device 110 may be connected to the source network device 120 using at least one of the direct path 140 and the indirect path 150. The terminal device 110 may stay in an RRC connected state.

Actions 210, 215, 220, and 230 in the process 400 are the same as those in the process 200. Details of these actions are omitted for brevity.

The process 400 is different from the process 200 in actions 425, 435, 440 and 445.

Specifically, upon receiving the response, the first network device 120 transmits 425, to the terminal device 110, a first reconfiguration message for mobility of the terminal device 110. The first reconfiguration message comprises the configuration for the multiple paths related to the second network device 160.

In some embodiments, the first network device 120 may transmit the first reconfiguration message by transmitting an RRC reconfiguration message.

In some embodiments, the first reconfiguration message may comprise an identifier (ID) of a target cell (such as the cell 124) and at least one ID of at least one target relay UE (such as the terminal device 132).

In some embodiments, the first reconfiguration message may comprise a third timer used for both direct path establishment and indirect path establishment. In other words, a single timer is configured to cover establishments of the direct path 142 and the indirect path 152.

Upon receiving the first reconfiguration message, the terminal device 110 starts 435 the third timer for both direct path establishment and indirect path establishment.

In turn, the terminal device 110 transmits 440 a reconfiguration complete message to the second network device 160. It shall be noted that in embodiments, the first network device 120 acts as both the source network device and the target network device, the terminal device 110 transmits the reconfiguration complete message to the first network device 120.

In some embodiments, the terminal device 110 may transmit the reconfiguration complete message by transmitting an RRC reconfiguration complete message.

In some embodiments, the terminal device 110 may transmit the reconfiguration complete message via the direct path 142.

In some embodiments, the terminal device 110 may transmit the reconfiguration complete message via the direct path 142 based on determining that the direct path 142 is successfully established and the indirect path 152 is successfully established. For example, the RRC reconfiguration complete message may be transmitted via the direct path 142 once the terminal device 110 successfully accesses the direct path 142 via random access and the terminal device 110 successfully established PC5 link.

In some embodiments, the terminal device 110 may transmit the reconfiguration complete message via the indirect path 152.

In some embodiments, the terminal device 110 may transmit the reconfiguration complete message via the indirect path 152 based on determining that the indirect path 152 is successfully established and the direct path 142 is successfully established. For example, the RRC reconfiguration complete message may be transmitted via the indirect path 152 once the terminal device 110 successfully accesses the direct path 142 via random access and the terminal device 110 successfully established PC5 link.

In some embodiments, the terminal device 110 may transmit the reconfiguration complete message via any of the multiple paths.

In some embodiments, the terminal device 110 may stop 445 the third timer for both direct path establishment and indirect path establishment after transmitting the reconfiguration complete message.

Alternatively, in some embodiments, the terminal device 110 may stop the third timer for both direct path establishment and indirect path establishment after the direct path 142 and the indirect path 152 are successfully established. For example, the terminal device 110 may stop the third timer once the terminal device 110 successfully accesses the direct path 142 via the random access procedure and the terminal device 110 successfully established PC5 link.

In some embodiments, the terminal device 110 may initiate a re-establishment procedure for the multiple paths based on determining that the third timer for both direct path establishment and indirect path establishment expires.

As described with reference to FIG. 2, upon deciding to perform a handover of the terminal device 110 from the cell 122 to the cell 124, the first network device 120 transmits 215, to the second network device 160, the request for mobility of the terminal device 110 served by the first network device 120. The request is associated with multiple paths related to the second network device 160.

In some embodiments, the request may comprise: an ID of a candidate cell; and at least one ID of at least one candidate relay terminal device.

In some embodiments, the first network device 120 may transmit the request by transmitting a handover request message comprising the request. In such embodiments, the second network device 160 may transmit the response by transmitting a handover request acknowledge message comprising the response.

In some embodiments, the second network device 160 may accept the candidate cell and reject the at least one candidate relay terminal device. For example, in embodiments where IDs of more than one candidate relay terminal devices are comprised in the request associated with the multiple paths, the second network device 160 may reject all the candidate relay terminal devices.

In such embodiments, the response may comprise a rejection indication indicating that the at least one candidate relay terminal device is rejected.

In some embodiments, the response may comprise a cause value associated with the rejection indication. The cause value indicates that the at least one candidate relay terminal device is rejected or overload.

In some embodiments, if the second network device 160 rejects the at least one candidate relay terminal device, the response may further comprise an ID of a candidate relay terminal device suggested by the second network device 160.

In some embodiments, the second network device 160 may accept one of the at least one candidate relay terminal device and reject the candidate cell. The response may comprise a rejection indication indicating that the candidate cell is rejected.

In some embodiments, the response may comprise a cause value associated with the rejection indication. The cause value indicates that the candidate cell is rejected or overload.

In some embodiments, the first network device 120 may transmit the request by transmitting a handover request message comprising the request. If the second network device 160 rejects the candidate cell or the at least one candidate relay terminal device, the second network device 160 may transmit the response by transmitting a handover request acknowledge message comprising the response. In such embodiments, it is assumed that the second network device 160 is not allowed to select one of the candidate cell and the candidate relay terminal device.

In such embodiments, the response may comprise a cause value indicating that one of the following is rejected or overload: the candidate cell, or the at least one candidate relay terminal device.

In such embodiments, if the second network device 160 rejects the at least one candidate relay terminal device, the response may further comprise an ID of a candidate relay terminal device suggested by the second network device 160.

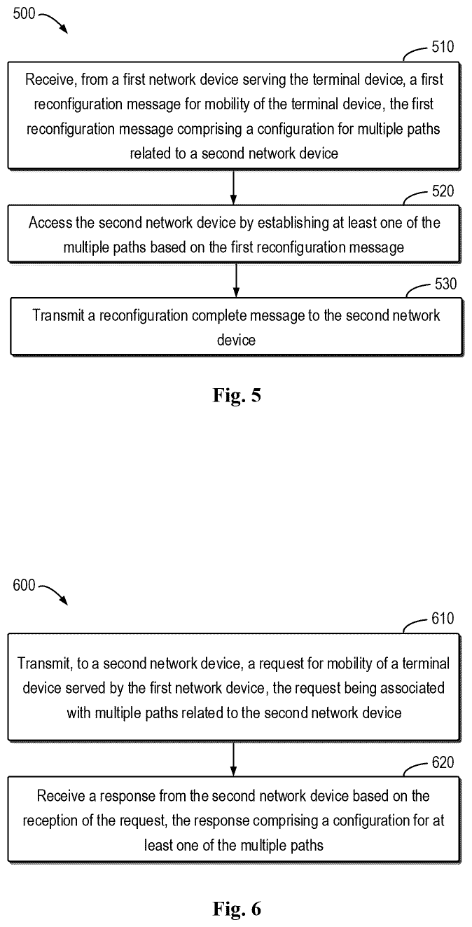

FIG. 5 illustrates a flowchart of a method 500 implemented at a terminal device in accordance with some embodiments of the present disclosure. For the purpose of discussion, the method 500 will be described from the perspective of the terminal device 110 with reference to FIG. 1A or 1B.

At block 510, the terminal device 110 receives, from the first network device 120 serving the terminal device 110, a first reconfiguration message for mobility of the terminal device. The first reconfiguration message comprises a configuration for multiple paths related to the second network device 160.

At block 520, the terminal device 110 accesses the second network device 160 by establishing at least one of the multiple paths based on the first reconfiguration message.

At block 530, the terminal device 110 transmits a reconfiguration complete message to the second network device 160.

In some embodiments, the multiple paths comprise a direct path and an indirect path.

In some embodiments, the terminal device 110 may transmit the reconfiguration complete message by one of the following: transmitting the reconfiguration complete message via the direct path based on determining that the direct path is successfully established; transmitting the reconfiguration complete message via the direct path based on determining that the direct path is successfully established and the indirect path is successfully established; or transmitting the reconfiguration complete message via the direct path based on determining that the direct path is successfully established and the indirect path fails to be established.

In some embodiments, if the first reconfiguration message for mobility includes a first timer for direct path establishment and a second timer for indirect path establishment, the terminal device 110 may stop the second timer for indirect path establishment after transmitting the reconfiguration complete message via the direct path.

In some embodiments, the terminal device 110 may transmit the reconfiguration complete message by one of the following: transmitting the reconfiguration complete message via the indirect path based on determining that the indirect path is successfully established; transmitting the reconfiguration complete message via the indirect path based on determining that the indirect path is successfully established and the direct path is successfully established; or transmitting the reconfiguration complete message via the indirect path based on determining that the indirect path is successfully established and the direct path fails to be established.

In some embodiments, the terminal device 110 may establish the direct path before establishing the indirect path; and the terminal device 110 may transmit the reconfiguration complete message by transmitting the reconfiguration complete message via the direct path.

In some embodiments, the terminal device 110 may establish the indirect path before establishing the direct path; and the terminal device 110 may transmit the reconfiguration complete message by transmitting the reconfiguration complete message via the indirect path.

In some embodiments, the terminal device 110 may transmit the reconfiguration complete message by transmitting the reconfiguration complete message via one of the multiple paths.

In some embodiments, if the first reconfiguration message for mobility includes a third timer for both indirect path establishment and direct path establishment, the terminal device 110 may stop the third timer after transmitting the reconfiguration complete message via the one of the multiple paths.

In some embodiments, the method 500 further comprises initiating a re-establishment procedure based on determining that the third timer expires.

In some embodiments, the method 500 further comprises: receiving, via the transceiver from the first network device, a second reconfiguration message indicating that the indirect path is to be released; and stopping a second timer for indirect path establishment based on the second reconfiguration message if the second timer is running.

FIG. 6 illustrates a flowchart of a method 600 implemented at a terminal device in accordance with some embodiments of the present disclosure. For the purpose of discussion, the method 600 will be described from the perspective of the first network device 120 with reference to FIG. 1A or 1B.

At block 610, the first network device 120 transmits, to the second network device 160, a request for mobility of a terminal device served by the first network device 120. The request is associated with multiple paths related to the second network device 160.

At block 620, the first network device 120 receives a response from the second network device 160 based on the reception of the request. The response comprises a configuration for at least one of the multiple paths.

In some embodiments, the request associated with the multiple paths comprises: an identifier of a candidate cell; and at least one identifier of at least one candidate relay terminal device.

In some embodiments, the response comprises a rejection indication indicating that the at least one candidate relay terminal device is rejected by the second network device.

In some embodiments, the rejection indication is associated with a cause value. The cause value indicates that the at least one candidate relay terminal device is rejected by the second network device or overload.

In some embodiments, the response further comprises an identifier of a candidate relay terminal device suggested by the second network device.

In some embodiments, the response comprises a rejection indication indicating that the candidate cell is rejected by the second network device.

In some embodiments, the rejection indication is associated with a cause value. The cause value indicates that the candidate cell is rejected by the second network device or overload.

In some embodiments, transmitting the request comprises transmitting a handover request message comprising the request; and receiving the response comprises receiving a handover request acknowledge message comprising the response.

In some embodiments, the response comprises a cause value indicating that one of the following is rejected by the second network device or overload: the candidate cell; or the at least one candidate relay terminal device.

In some embodiments, the cause value indicates that the at least one candidate relay terminal device is rejected or overload; and the response further comprises an identifier of a candidate relay terminal device suggested by the second network device.

In some embodiments, transmitting the request comprises transmitting a handover request message comprising the request; and receiving the response comprises receiving a handover preparation failure message comprising the response.

FIG. 7 illustrates a flowchart of a method 700 implemented at a terminal device in accordance with some embodiments of the present disclosure. For the purpose of discussion, the method 700 will be described from the perspective of the second network device 160 with reference to FIG. 1B.

At block 710, the second network device 160 receives, from the first network device 120, a request for mobility of a terminal device served by the first network device 120. The request is associated with multiple paths.

At block 720, the second network device 160 transmits a response to the request to the first network device 120 based on the reception of the request. The response comprises a configuration for at least one of the multiple paths.

In some embodiments, the request associated with the multiple paths comprises: an identifier of a candidate cell; and at least one identifier of at least one candidate relay terminal device.

In some embodiments, the method 700 further comprises: accepting the candidate cell and rejecting the at least one candidate relay terminal device; and the response comprises a rejection indication indicating that the at least one candidate relay terminal device is rejected.

In some embodiments, the rejection indication is associated with a cause value, the cause value indicating that the at least one candidate relay terminal device is rejected or overload.

In some embodiments, the response further comprises an identifier of a candidate relay terminal device suggested by the second network device.

In some embodiments, the method 700 further comprises: accepting one of the at least one candidate relay terminal device; and rejecting the candidate cell; and the response comprises a rejection indication indicating that the candidate cell is rejected.

In some embodiments, the rejection indication is associated with a cause value, the cause value indicating that the candidate cell is rejected or overload.

In some embodiments, receiving the request comprises receiving a handover request message comprising the request; and transmitting the response comprises transmitting a handover request acknowledge message comprising the response.

In some embodiments, the response comprises a cause value indicating that one of the following is rejected or overload: the candidate cell; or the at least one candidate relay terminal device.

In some embodiments, the cause value indicates that the at least one candidate relay terminal device is rejected or overload; and the response further comprises an identifier of a candidate relay terminal device suggested by the second network device.

In some embodiments, receiving the request comprises receiving a handover request message comprising the request; and transmitting the response comprises transmitting a handover preparation failure message comprising the response.

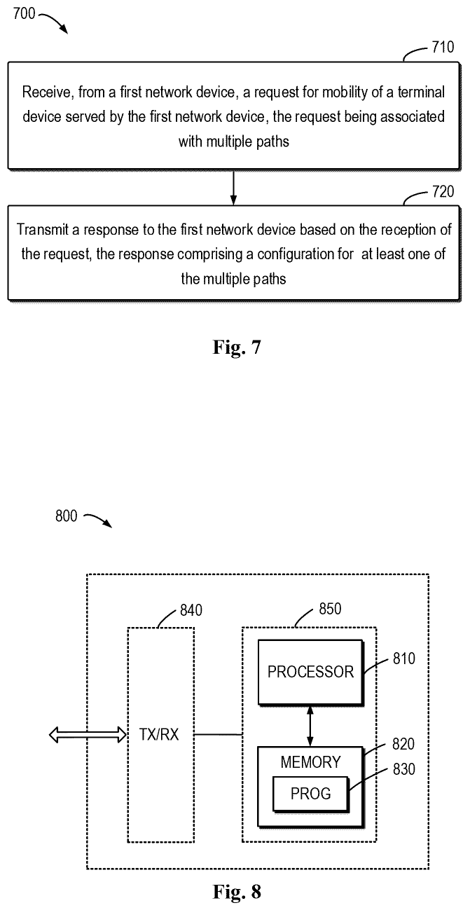

FIG. 8 illustrates a simplified block diagram of an apparatus 800 that is suitable for implementing embodiments of the present disclosure. The apparatus 800 can be considered as a further example implementation of the terminal device 110 or the first network device 120 as shown in FIGS. 1A and 1B or the second network device 160 as shown in FIG. 1B. Accordingly, the apparatus 800 can be implemented at or as at least a part of the terminal device 110, the first network device 120 or the second network device 160.

As shown, the apparatus 800 includes a processor 810, a memory 820 coupled to the processor 810, a suitable transmitter (TX) and receiver (RX) 840 coupled to the processor 810, and a communication interface coupled to the TX/RX 840. The memory 810 stores at least a part of a program 830. The TX/RX 840 is for bidirectional communications. The TX/RX 840 has at least one antenna to facilitate communication, though in practice an Access Node mentioned in this disclosure may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 830 is assumed to include program instructions that, when executed by the associated processor 810, enable the apparatus 800 to operate in accordance with the embodiments of the present disclosure, as discussed herein with reference to FIGS. 1A to 7. The embodiments herein may be implemented by computer software executable by the processor 810 of the apparatus 800, or by hardware, or by a combination of software and hardware. The processor 810 may be configured to implement various embodiments of the present disclosure. Furthermore, a combination of the processor 810 and memory 820 may form processing means 850 adapted to implement various embodiments of the present disclosure.

The memory 820 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 820 is shown in the apparatus 800, there may be several physically distinct memory modules in the apparatus 800. The processor 810 may be of any type suitable to the local technical network, and may include one or more of general purpose computers, special purpose computers, microprocessors, digital signal processors (DSPs) and processors based on multicore processor architecture, as non-limiting examples. The apparatus 800 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A terminal device for wireless communication, comprising:
at least one memory; and
at least one memory coupled with the at least one processor and configured to cause the terminal device to:
receive, from a first network device serving the terminal device, a first reconfiguration message for mobility of the terminal device, wherein the first reconfiguration message comprises a configuration for multiple paths related to a second network device;
access the second network device by establishing at least one of the multiple paths based on the first reconfiguration message; and
transmit a reconfiguration complete to the second network device.

2. The terminal device of claim 1, wherein the multiple paths comprise a direct path and an indirect path.

3. The terminal device of claim 2, wherein the at least one processor is configured to cause the terminal device to transmit the reconfiguration complete message by:
transmitting the reconfiguration complete message via the direct path based on determining that the direct path is successfully established;
transmitting the reconfiguration complete message via the direct path based on determining that the direct path is successfully established and the indirect path is successfully established; or
transmitting the reconfiguration complete message via the direct path based on determining that the direct path is successfully established and the indirect path fails to be established.

4. The terminal device of claim 3, wherein, when the first reconfiguration message for mobility includes a first timer for direct path establishment and a second timer for indirect path establishment,
stop the second timer for indirect path establishment after transmitting the reconfiguration complete message via the direct path.

5. The terminal device of claim 2, wherein the at least one processor is configured to cause the terminal device to transmit the reconfiguration complete message by:
transmitting the reconfiguration complete message via the indirect path based on determining that the indirect path is successfully established;
transmitting the reconfiguration complete message via the indirect path based on determining that the indirect path is successfully established and the direct path is successfully established; or
transmitting the reconfiguration complete message via the indirect path based on determining that the indirect path is successfully established and the direct path fails to be established.

6. The terminal device of claim 2, wherein the at least one processor is configured to cause the terminal device to establish the direct path before establishing the indirect path; and
wherein the at least one processor is configured to cause the terminal device to transmit the reconfiguration complete message by transmitting the reconfiguration complete message via the direct path.

7. The terminal device of claim 2, wherein the at least one processor is configured to cause the terminal device to establish the indirect path before establishing the direct path; and
wherein the at least one processor is configured to cause the terminal device to transmit the reconfiguration complete message by transmitting the reconfiguration complete message via the indirect path.

8. The terminal device of claim 1, wherein the at least one processor is configured to cause the terminal device to transmit the reconfiguration complete message by transmitting the reconfiguration complete message via one of the multiple paths.

9. The terminal device of claim 2, wherein the at least one processor is further configured to cause the terminal device to:
receive, from the first network device, a second reconfiguration message indicating that the indirect path is to be released; and
stop a second timer for indirect path establishment based on the second reconfiguration message when the second timer is running.

10. The terminal device of claim 1, wherein the first network device is the same as or different from the second network device.

11. A first network device for wireless communication, comprising:
at least one memory; and
at least one processor coupled with the at least one memory and configured to cause the first network device to:
transmit, to a second network device, a request for mobility of a terminal device served by the first network device, wherein the request associated with multiple paths related to the second network device; and
receive a response from the second network device based on the reception of the request, wherein the response comprises a configuration for at least one of the multiple paths.

12. The first network device of claim 11, wherein the request associated with the multiple paths comprises:
an identifier of a candidate cell; and
at least one identifier of at least one candidate relay terminal device.

13. The first network device of claim 11, wherein the response comprises a rejection indication that indicates the at least one candidate relay terminal device is rejected by the second network device.

14. A second network device for wireless communication, comprising:
at least one memory; and
at least one processor coupled with the at least one memory and configured to cause the second network device to:
receive, from a first network device, a request for mobility of a terminal device served by the first network device, wherein the request is associated with multiple paths; and
transmit a response to the first network device based on the reception of the request, wherein the response comprises a configuration for at least one of the multiple paths.

15. The second network device of claim 14, wherein the request associated with the multiple paths comprises:
an identifier of a candidate cell; and
at least one identifier of at least one candidate relay terminal device.

16. The second network device of claim 15, wherein the at least one processor is further configured to cause the second network device to:
accept the candidate cell; and
reject the at least one candidate relay terminal device; and
wherein the response comprises a rejection indication indicating that the at least one candidate relay terminal device is rejected.

17. The second network device of claim 16, wherein the rejection indication is associated with a cause value, the cause value indicating that the at least one candidate relay terminal device is rejected or overload.

18. The second network device of claim 16, wherein the response further comprises an identifier of a candidate relay terminal device suggested by the second network device.

19. The second network device of claim 15, wherein the at least one processor is further configured to cause the second network device
accept at least one candidate relay terminal device; and
reject the candidate cell; and
wherein the response comprises a rejection indication indicating that the candidate cell is rejected.

20. A method performed by a terminal device, the method comprising:
receiving, from a first network device serving the terminal device, a first reconfiguration message for mobility of the terminal device, wherein the first reconfiguration message comprises a configuration for multiple paths related to a second network device;
accessing the second network device by establishing at least one of the multiple paths based on the first reconfiguration message; and
transmitting a reconfiguration complete to the second network device.
